(19) United States
(12) Patent Application Publication
(10) Pub. No.: US 2022/0403722 A1
(43) Pub. Date: Dec. 22, 2022

(54) METHOD OF FORECASTING WELL PRODUCTION

(71) Applicant: ENOVATE CORP., Spring, TX (US)

(72) Inventors: Miguel Camilo Mejia, Houston, TX (US); Oscar Mauricio Molina Ortiz, Plano, TX (US); Oswaldo Perez Briceno, Katy, TX (US); Laura Patricia Santos Ortiz, Houston, TX (US); Abzal Seitkaziyev, Sugar Land, TX (US)

(21) Appl. No.: 17/893,624

(22) Filed: Aug. 23, 2022

Related U.S. Application Data
(63) Continuation-in-part of application No. 17/881,284, filed on Aug. 4, 2022.
Application No. 17/881,284 is a continuation-in-part of application No. 16/912,042, filed on Jun. 25, 2020, now Pat. No. 11,421,521.
Application No. 16/912,042 is a continuation-in-part of application No. 16/789,150, filed on Feb. 12, 2020, now Pat. No. 11,308,409.

(51) Int. Cl. E21B 43/26

(52) U.S. Cl. CPC E21B 43/26; E21B 2200/20

(57) ABSTRACT

A method of forecasting well production in an accurate and computational cost-efficient manner implementing a hybrid, iterative approach which is computationally efficient, numerically stable, and improves the accuracy of results. The iterative method of forecasting well production can estimate a set of scaling factor, determining the average adjusted pressure in the matrix, conductive reservoir volume, and oriented hydraulic fracture, applying an algorithm to convert the average adjusted pressure to an actual average pressure, using actual average reservoir pressure to estimate a new set of scaling factor, estimating a relative error based upon the new scaling factor, determining if the relative error is within a user-defined tolerance, and performing the above steps again if relative error is not within the user-defined tolerance or storing the new scaling factors. The new scaling factors can be used to determine a production rate. A second approach implements statistical, data analytics, and pattern recognition techniques.

### CROSS REFERENCE TO RELATED APPLICATIONS

The present application is a Continuation in Part and claims priority to and the benefit of co-pending U.S. patent application Ser. No. 17/881,284 filed on Aug. 4, 2022, titled “COMPUTER IMPLEMENTED METHOD OF DETERMINING FRACTURE INTERFERENCE IN A HYDRAULICALLY FRACTURED WELL,” which is a Continuation in Part of co-pending U.S. patent application Ser. No. 16/912,042 filed on Jun. 25, 2020, titled “METHOD OF OPTIMIZING RATE OF PENETRATION,” issued as U.S. Pat. No. 11,421,521 on Aug. 23, 2022, which is a Continuation in Part and claims priority to and the benefit of U.S. patent application Ser. No. 16/789,150 filed on Feb. 12, 2020, titled “METHOD OF DETERMINING FRACTURE INTERFERENCE IN A HYDRAULICALLY FRACTURED WELL,” issued as U.S. Pat. No. 11,308,409 on Apr. 19, 2022. These references are incorporated in entirety herein.

### FIELD

The present disclosure generally relates to methods of predicting and forecasting the production of a well.

### BACKGROUND

Many aspects of drilling a well can be enhanced to improve economic efficiency at each stage. While the present disclosure deals with a specific issue, the disclosed methods can be analogized and/or used in conjunction with other methods during the drilling, completion, evaluation, or production phases of a well in order to achieve optimal financial performance of a well.

When dealing with hydrocarbons, in order to maximize well productivity, thus increasing economic efficiency from tight rocks, several horizontal wells are often drilled in relatively close proximity. Such an arrangement of horizontal wells is often called a multi-well pad. Typically, new wells (i.e. infill, target, or child wells) are landed next to older, depleted wells (i.e. parent, existing, or offset wells). Other wells may also be drilled in such a manner.

Currently, in the art, it is difficult or cost prohibitive to predict production rates from wells, especially in situations where interference from nearby wells can complicate analyses.

It is desirable to forecast production, both at a design stage, and in real time while drilling a well. Furthermore, it is desirable to have a simple, cost effective, and fast method of accurately forecasting well production.

Currently utilized analytical models either ignore elements such as pressure-dependent fluid properties, geomechanics, heterogeneous rock properties, or engineered completions, or treat them in an overly simplistic manner. Currently utilized numerical models are more accurate and incorporate complex physics but are cost prohibitive due to the computational power required.

The present disclosure provides methods for accurately forecasting well production by combining analytical models with numerical solvers to generate a hybrid model which is fast, robust and accurate.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to forecasting well production in an accurate and cost-efficient manner.

Currently, due to computational cost considerations, analytical models are utilized to predict production from a multi-fractured horizontal well. However, typical analytical models make use of assumed rock properties which remain constant. This causes the methods currently utilized to be inaccurate because the permeability of the matrix (host rock) and stimulated reservoir volume, as well as the conductivity of hydraulic fractures vary as pressure changes and the in-situ stress condition changes.

Mathematical models for multi-fractured horizontal wells can incorporate geomechanical effects in order to account for changes in permeability and fracture conductivity. However, this results in complex non-linear partial differential equations, which can only be solved with many assumptions.

The present disclosure addresses these deficiencies by implementing a hybrid, iterative approach which is computationally efficient, numerically stable, and improves the accuracy of results. The method also includes automated event detection and a fitting of production rate decline curves approach to predict the future production of wells in a cost-efficient manner.

Persons having ordinary skills in the art will be aware of relationships between geomechanical properties of oil and gas reservoirs and/or other reservoirs such as geothermal reservoirs. It is desirable to have a framework coupling of geomechanics and fracture properties with fluid-flow in porous media. However, complex fracture shapes make this a challenging prospect. A large variety of correlations between in-situ stresses, porosity and permeability, as well as fracture conductivity exist in the literature and they all can be used and implemented.

The inclusion of geomechanics into the fluid-flow model often yields a system of highly nonlinear partial differential equations which may be solved under certain, often restrictive, assumptions.

The present methods make use of an adjusted pressure to develop a set of non-linear governing equations. Adjusted pressure (Pₐⱼ) is defined as:

$${P}_{aj} = {P}_{a} ( {p}_{j} ) = \frac{{μ}_{ref}}{{ρ}_{ref}} {\int }_{0}^{{p}_{j}} \frac{ρ}{μ} dp$$

Here, j refers to a region in or near a conductive reservoir volume (CRV) and ρ_{ref} and μ_{ref} refer to fluid density and viscosity measured at reference pressure, respectively.

The conductive reservoir volume (CRV) is the effective rock volume that contributes to production. It represents the retained resultant conductivity of a stimulation treatment after damage and initial depletion effects have taken place. The CRV can be generated in a matrix-acidized rock region, a frac-packed region, or a hydraulic-fractured rock region.

The matrix-acidizing region is the volume of the reservoir that has been stimulated by the injection of treatment fluids at rates below fracture pressure.

The frac-packed region is created to avoid producing sand from the well. The frac-packed region can have a frac pack, which is a short-extent hydraulic fracture designed to generate high conductivity limited to the near wellbore area which can also be combined with a gravel pack, which is a sand control method or sand control region that consists of screens or filters inside the wellbore to prevent sand production. The annular space (screen outer diameter−casing inner diameter) can be packed with proppant.

The hydraulic fracture region is the reservoir volume that has been fractured via injection of low or high viscosity proppant laden fluid at a pressure above the fracture gradient of the reservoir. The proppant is designed to keep the generated fracture open and allow a highly conductive path for hydrocarbon flow.

The iterative method of forecasting well production can comprise estimating a scaling factor, determining the average adjusted pressure in the matrix-acidized region, frac-packed region, hydraulic fracture region, or combinations thereof, applying an iterative algorithm to convert the average adjusted pressure to an actual average pressure, using the actual average pressure to estimate a new scaling factor, estimating a relative error based upon the new scaling factor, determining if the relative error is within a user-defined tolerance, performing the above steps again if relative error is not within the user-defined tolerance, or storing the new scaling factor if the relative error is within the user-defined tolerance.

The new scaling factor or factors can be used to determine a production rate. In embodiments, the new scaling factors can be estimated over time, and a production rate can thus be determined over time. The production rate can be integrated over time to determine a total cumulative production.

Scaling factors can be a series of nonlinear parameters which are a function of average reservoir pressure. These scaling factors can then be implemented in nonlinear governing equations. The scaling factors capture the various geomechanics and pressure-dependent properties of the well. An exemplary scaling factor can be:

λⱼ(\tilde{p}ⱼ)

Wherein λⱼ is the scaling factor, and \tilde{p}ⱼ is an average pressure for each j, which is a region of the reservoir, such as the matrix, conductive reservoir volume, or hydraulic fracture. The estimated scaling factor can be assumed as a constant to simplify the necessary calculations. In embodiments, additional scaling factors (such as δⱼᵢ) can be utilized for pressure and flux-continuity boundary conditions across two different regions, i and j, which can represent the matrix, stimulated reservoir volume, and hydraulic fracture.

Using the scaling factors, the adjusted pressure is converted to actual pressure at a given time. One exemplary method of this can make use of the following equation:

$${P}_{a}^{- 1} ( {P}_{a} ( {p}^{n} ) ) = {p}^{n} \approx {p}^{n - 1} + \frac{( {μ}^{n - 1} / {ρ}^{n - 1} )}{( {μ}_{ref} / {ρ}_{ref} )} ( {P}_{a} ( {p}^{n} ) - {P}_{a} ( {p}^{n - 1} ) )$$

Here, pⁿ is pressure at current time level n, pⁿ⁻¹ pressure at a previous time step n−1.

This method requires knowledge of pressure at previous time steps thus making it suitable for iterative schemes. Adjusted pressure is converted to pressure within the nonlinear iterative algorithm to estimate new values of λⱼ and δⱼᵢ at each simulation time step, resulting in a new scaling factor.

At this stage a relative error can be determined of the scaling factor or factors, as well as the actual pressure. If the relative error is not less than a user-defined value, the above steps can be repeated iteratively until the relative error meets the user criteria. Otherwise, the new scaling factor can be stored.

This process can be iterated over time, and the results totaled to result in an accurate prediction of well production. The forecast well production can be utilized to set sale prices for produced products, determine maintenance schedules, order or schedule needed resources and supplies, determine operating budgets, or any other action requiring accurate production forecasts. These activities can be adjusted automatically in real time as the iterative process hones the production forecast.

In embodiments, the method can be implemented by a computer to then optimize various well parameters. This allows for operational flexibility and more accurate economic forecasting.

The methodology comprises an additional approach that accounts for model simplification that can optionally be applied in wells where parameters are not available, or the parameter accuracy does not meet the desired reliability. The approach makes use of the production rate data of the individual wells and/or field production data, which is preprocessed using statistical and data analytics techniques, for example, to identify outliers, and/or normalize the data. Exemplary preprocessing can include clustering analyses and creating visual representations of data, such as tables, plots, bar charts, diagrams, and the like.

The approach applies pattern recognition techniques like Change Point Detection to identify production events automatically. Also, optionally, other machine learning algorithms can be used to identify production cycle events as a supplemental or independent approach. Any event that significantly impacts the production of the well (whether increasing or decreasing) should be identified. Exemplary events that affect production include, but are not limited to recompletions, workovers, significant sand production (plugging), and the like.

At this stage, the approach automatically fits decline curves at identified events. One exemplary decline curve can be described by Arps hyperbolic equation (Q(t)=Q₀×(1+b×D₀×t)^{-1/b}) as a default. Using this equation, the production rate ‘Q’ at any time ‘t’ can be calculated from the hyperbolic exponent ‘b’, the initial production rate ‘Q₀’ and its corresponding decline rate ‘D₀’ at time zero. Persons having ordinary skill in the art can also implement other hyperbolic decline curves, exponential decline curves, harmonic decline curves, and the like.

Optionally the decline curve can be any function defined by the user/production engineer. Once the curve fit and parameters of the curve function are identified, the production forecast is calculated and updated for every major production cycle in order to reflect the actual and true production trend of the well.

The described additional approach can be used with historical data, and/or with real-time data, and/or a combination of both data types.

The methodology is intended to be applied but not limited to oil and gas wells, and/or geothermal wells. Persons having ordinary skill in the art will recognize that any well producing a product can be accurately forecasted utilizing the methodology in this disclosure.

While the present disclosure emphasizes the presented embodiments, it should be understood that within the scope of the appended claims, the disclosure might be embodied other than as specifically enabled herein.

What is claimed is:

1. An iterative method of forecasting well production, comprising:
a. estimating a scaling factor;
b. determining an estimate of average adjusted pressure in different regions within a conductive reservoir volume of a multi-fractured horizontal well, wherein the regions are at least one of:
(i) a matrix-acidized region;
(ii) a frac-packed region; and
(iii) a hydraulic fracture region;
c. applying an iterative algorithm to convert the estimate of average adjusted pressure to an actual average pressure in the conductive reservoir volume, the matrix-acidized region, the frac-packed region, the hydraulic fracture region, or combinations thereof;
d. using the actual average pressure to estimate a new scaling factor;
e. estimating a relative error based upon the new scaling factor;
f. determining if the relative error is within a user-defined tolerance;
g. performing the above steps again if the relative error is not within the user-defined tolerance, or storing the new scaling factor if the relative error is within the user-defined tolerance;
h. using the new scaling factor to determine a production rate;
i. forecasting well production in real time; and
j. adjusting well parameters to achieve a desired well production.

2. The method of claim 1, further comprising:
a. estimating a new scaling factor over time; and
b. determining a production rate over time.

3. The method of claim 2, further comprising calculating a total cumulative production value.

4. The method of claim 3, further comprising calculating the total cumulative production value by integrating the production rate over time.

5. The method of claim 4 wherein the method is implemented by a computer and well parameters are automatically adjusted.

6. A method of automated event detection and fitting production rate decline curves for forecasting well production, comprising:
a. acquiring a production rate or field production data on an individual well or group of wells to create acquired data;
b. preprocessing the acquired data using statistical and data analytics techniques;
c. applying pattern recognition techniques to preprocessed production data to identify production cycle events automatically;
d. automatically fitting decline curves at identified events; and
e. estimating production forecast using parameters of a curve function identified by the fitting decline curves at the identified events.

7. A method of automated event detection and fitting production rate decline curves for forecasting well production, comprising:
a. acquiring a production rate or field production data on an individual well or group of wells to create acquired data;
b. preprocessing the acquired data using statistical and data analytics techniques;
c. using machine learning algorithms to identify production events;
d. automatically fitting decline curves at identified events; and
e. estimating production forecast using parameters of a curve function identified by the fitting decline curves at the identified events.
